(19) United States
(12) Patent Application Publication
(10) Pub. No.: US 2007/0225827 A1
(43) Pub. Date: Sep. 27, 2007

(54) Computer everywhere wall system

(76) Inventor: Jay Coker Tankersley, Georgetown, TX (US)

Correspondence Address: Jay Tankersley, 2002 Singing Hills, Leander, TX, 78641, US

(21) Appl. No.: 11/370,501

(22) Filed: Mar. 8, 2006

(51) Int. Cl. G05B 11/01

(52) U.S. Cl. 700/11

(57) ABSTRACT

For the need for a computer user to be able to work with any wired room or office and operate a computer or select from multiple computers that are located in a closet or different location. A Computer Everywhere Wall System Panel would allow a user to plug in a monitor and use a wired or wireless keyboard and mouse to operate a computer or computers that are located in a different area of a home or office. A DVD CD RW players and the Computer Everywhere Wall System Panel would allow full operation of a host computer or computers wired to the controller to be operated to their full capacity.

### BACKGROUND OF INVENTION

This invention relates in general to the ability to control one or multiple computers that are located in one area of a home or business, from other rooms using a wired mounted control pad. In particular, the invention relates to a process for using a wired auxiliary panel similar to the back of a traditional computer port and a CD/RW DVD player to send data back to a computer located in another room. This would allow computer access in any or every room in a house or business simply by plugging in a monitor/TV, and even utilizing a wireless keyboard and mouse. This enables the computer to be utilized as a port for internet phones and even internet TV broadcast in any room or every room of a house or office.

When computers are typically used in a home or office, the base unit, or tower, is usually sitting beside the desk or workspace. If multiple computer units are utilized in a workspace, home or office multiple base units or towers are located beside each workspace. This means an array of wires, plugs and components must be within the workspace in order to utilize the equipment in order to perform a specific task. This means excess heat and noise are present at a workstation due to computer components and cooling fans. Laptops or portable computers are typically much smaller in size but sometimes are to mobile for a base unit and can be limited to certain peripheral devices because of port and wiring problems.

Search fee paid, for commissioner of patents to conduct search of like patents

### SPECIFICS OF INVENTION

There are no like methods of using a computer that can satisfactorily allow a person or persons to completely utilize a computer in another room without having to deal with the noise, heat and array of wires. A need remains for a way to operate a computer from where the user has the desire, while allowing the base unit/units or tower/towers to operate in an area that isolates the user from the heat, noise and clutter of wires. A need remains for a way for the user to operate the same computer and access information from any room he or she would like. A need remains for a user to operate any computer they would like to have access to, within the home or office, from anywhere they would like. A need remains for a way to access internet phones and internet TV from any room of a house or office while allowing the base unit/units or tower/towers to be isolated from the user.

In general, the desired features and advantages of the invention are achieved by mounting a wired access panel within a wall or piece of furniture, that would allow full compatibility of the computer it's connected to. The advantages are achieved by having full port access to the computer from every room of a home or office, while eliminating the noise, heat and wires typically associated with a computer system. This would allow the user to walk up to the Computer Everywhere Wall System, and simply select which computer he or she would like to turn on at the remote location, and access a monitor or TV by plugging it to the monitor port or by a pre-wired method and use a wireless keyboard and mouse to send data to the computer and start working or playing. The actual panel could be custom built per customer needs and request, that would allow various peripheral units to be utilized in various rooms. Sound ports would normally come standard allowing computer speakers to be pulled out of a drawer or storage device and simply plugged into the port and have sound. More elaborate systems can have speakers permanently built into the wall or ceiling, that would have no visible wires and provide surround sound. Basically speaking all control would be taken away from the tower or computer base unit and give the control in various rooms where the user wanted to be. The Computer Everywhere Wall System panels would be as small as possible, mounted in the wall and covered with a retractable faceplate when not in use. It truly will change the place and way people are able to utilize computers.

The Computer Everywhere Wall System has a major advantage from other systems because it takes the main tower/towers to a central location allowing more rooms to be computer accessible without having multiple tower units. It also frees the user and room from the heat, noise and wires that are generally associated with a computer.

Additional features and advantages of the invention will become apparent in the following detailed descriptions in the drawings.

### DRAWING DETAIL

FIG. 1 depicts the Computer Everywhere Wall System flush mount panel faceplate itself. This port faceplate has multiple ports and controls on the unit. The ports and controls could be custom configured for the user's specific need. Therefore the drawing is one example of the way the faceplate could be configured. Also as technology changed over the years, new ports and controls could be added as needed or desired. #1 on FIG. 1 depicts a monitor port. This would allow a user to simply carry a monitor to a room and plug into the port faceplate and have the computer image from the base unit he/she selected. #2 FIG. 1 depicts a keyboard port. This would allow the user to use a wired keyboard wherever was needed by plugging into the keyboard port. #3 on FIG. 1 depicts a mouse port. This would allow the user to use a wired mouse wherever was needed by plugging into the mouse port. #4 on FIG. 1 depicts an Infrared Wireless Port. This would allow the user to use a wireless keyboard and mouse to control any of the host computers. #5 on FIG. 1 depicts 4 USB Ports. This would allow a user to plug in a variety of peripheral devices such as printers, camera, scanners etcetera into the USB ports and send and receive data from the host computer. #6 on FIG. 1 depicts the on/off pushbuttons and computer select buttons. These buttons are used to turn the host computers on and off, and select which host computer the user would like to utilize. This means the user could for example push button 2 which would select host computer number 2 to be utilized by the user. #7 on FIG. 1 depicts a speaker out port. This would allow the user to plug in external speakers into the port and hear sound from the host computer selected. #8 on FIG. 1 depicts an internet phone port. This would allow the user to have phone access at the port faceplate. #9 on FIG. 1 depicts expansion ports. This area would be for future ports and controls that were needed. #10 on FIG. 1 depicts a volume control. This would allow a user to control the volume of external, wall mounted or monitor speakers. #11 on FIG. 1 depicts a coaxial or internet TV connection. This port would allow users to interface with cable or Internet TV.

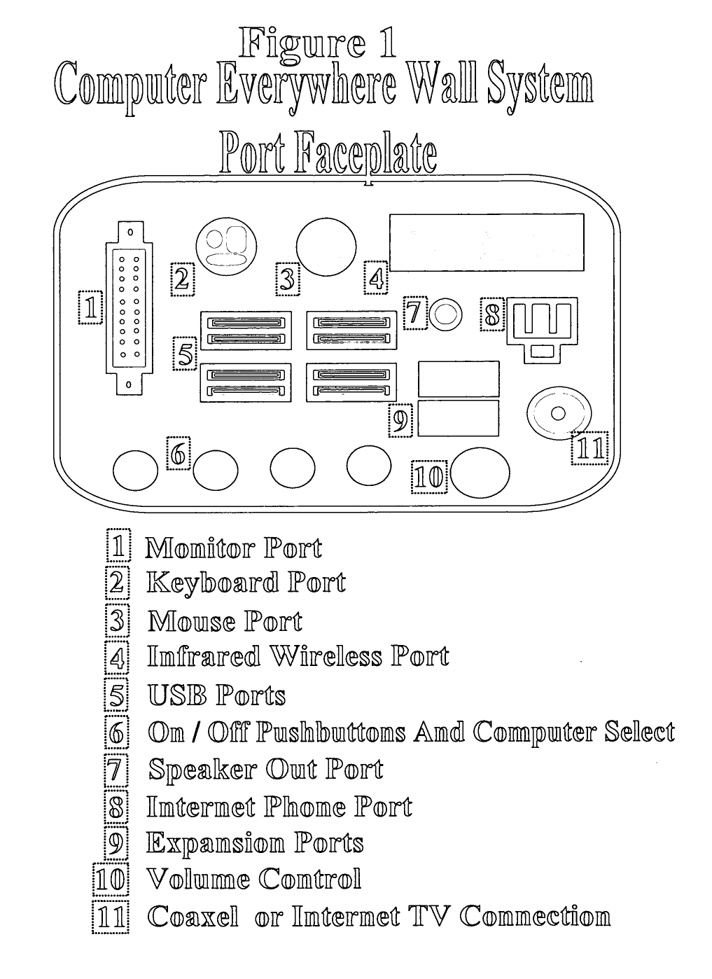

FIG. 2 depicts a faceplate Cover for the Computer Everywhere Wall System panel faceplate. This faceplate cover could be made from a variety of materials such as plastic, metal, wood etcetera. It would flip down to cover the faceplate when the faceplate was not in use. It could also be motorized where the user would simply push a button on the side of the unit or remotely to open or close the faceplate cover. The faceplate cover could also be inscribed with a company's logo for advertisement purposes. Google was used in #2 as an example of advertising on the faceplate cover. #1 on FIG. 2 depicts the faceplate in it's open position. #2 on FIG. 2 depicts the faceplate in it's closed position.

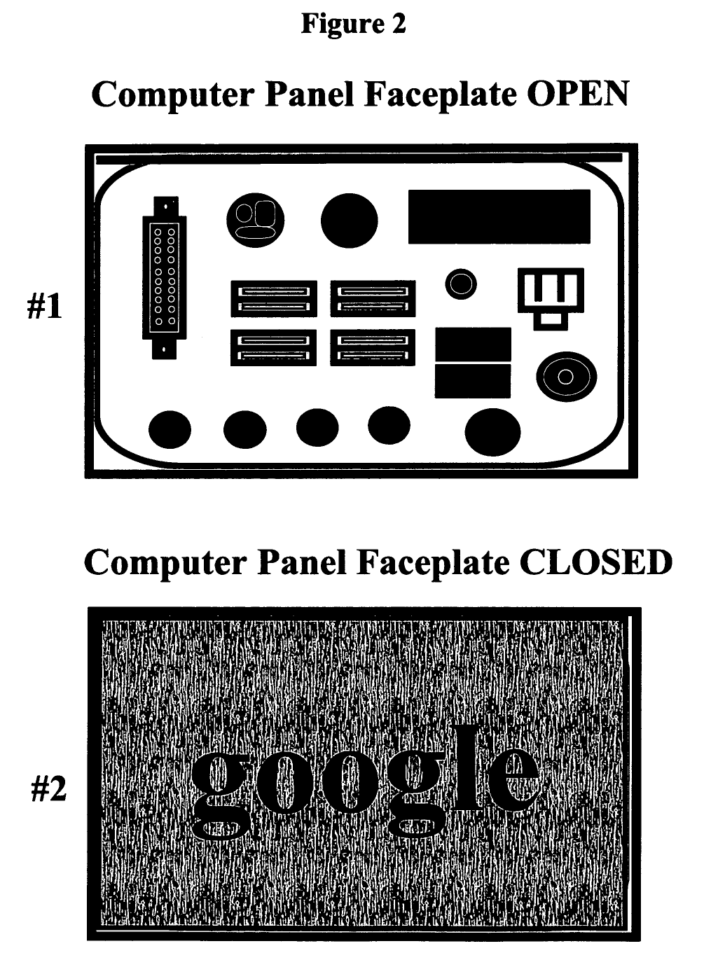

FIG. 3 depicts a Computer Everywhere Wall System faceplate mounted flush in the wall. This drawing depicts a wall in a home or office that has the PC Port (#1) flush mounted in it. Under the Faceplate (#2) is a CD/RW DVD Player. These components are all wired back to the host PC'S in another room. The CD/RW DVD Player could be mounted in the wall or under a piece of existing furniture in a specific room. This drawing is an example of a typical room in a home or office.

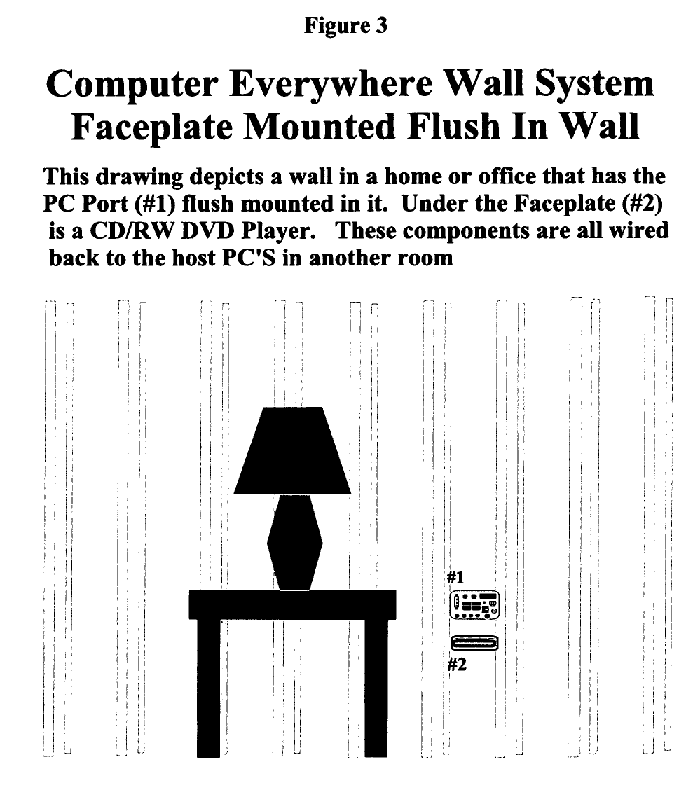

FIG. 4 depicts the Computer Everywhere Wall System in a typical host closet. This closet can be located anywhere in a home or office. It would hold the host computers and the Computer Everywhere Wall System Control Box. This would allow the user to be separate from the noise heat and wires associated with computer systems. #1 on FIG. 4 depicts the conduit access to the other rooms. This simply shows a route for wire to leave the closet and go to the flush mounted ports in various rooms. #2 on FIG. 4 depicts Wire from the controller to other rooms. Other rooms would have PC Port at other end of wire. #3 on FIG. 4 depicts a PC Port Controller that controls which PC is utilized from what room. #4 on FIG. 4 depicts wires from PC to PC Controller. This drawing is for example only, any room can be utilized as well as a closet.

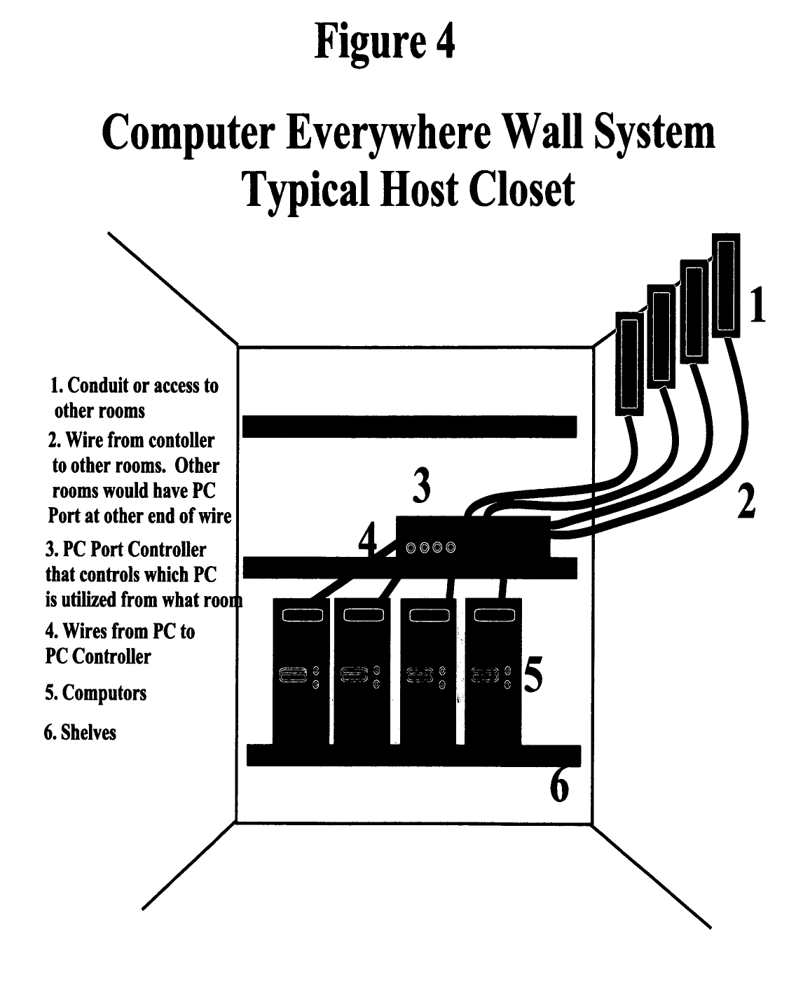

FIG. 5 depicts the Computer Everywhere Wall System for a typical floor plan. This drawing shows the closet where the controller and host computers are stored. It shows the wiring routes in the attic and walls that lead to the flush mount panels in many of the rooms. This drawing shows the versatility of the system that allows the user or architect to choose where they would like the flush mount panels to be located for ease of use. Floor plan is just an example of a typical home design. Color was used on wire for clarity.

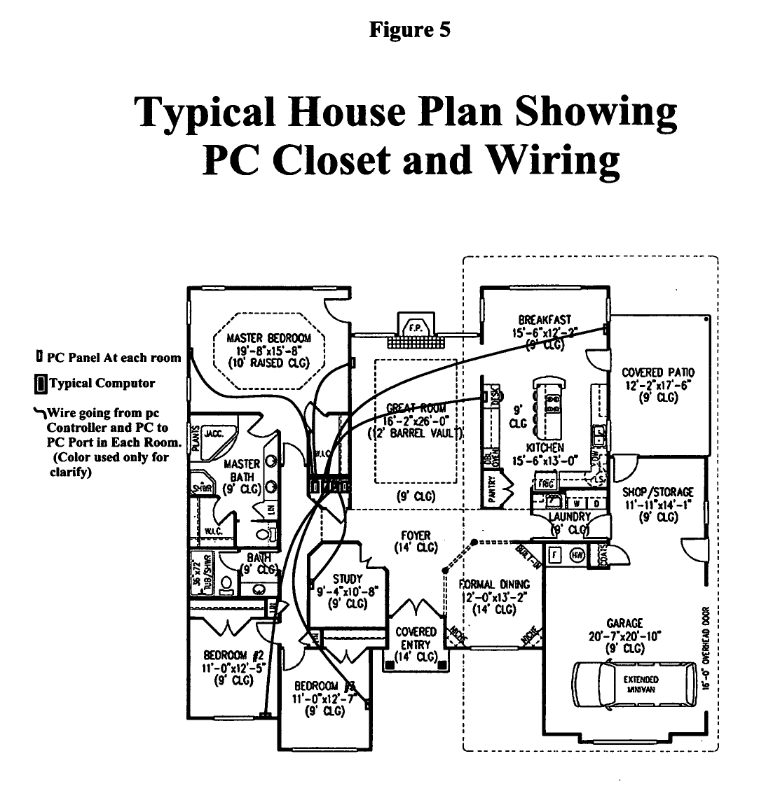

FIG. 6 depicts the Computer Everywhere Wall System Control Box. This control box acts as a switching unit and an avenue to connect the host computers to the panel ports. It has input ports that mirror the back of a typical Computer, and output ports that mirror the faceplate ports. The control box also allows the user to pick which host computer he/she wishes to operate from a specific faceplate port room. Multiple users could operate multiple computers from various faceplate ports at the same time.

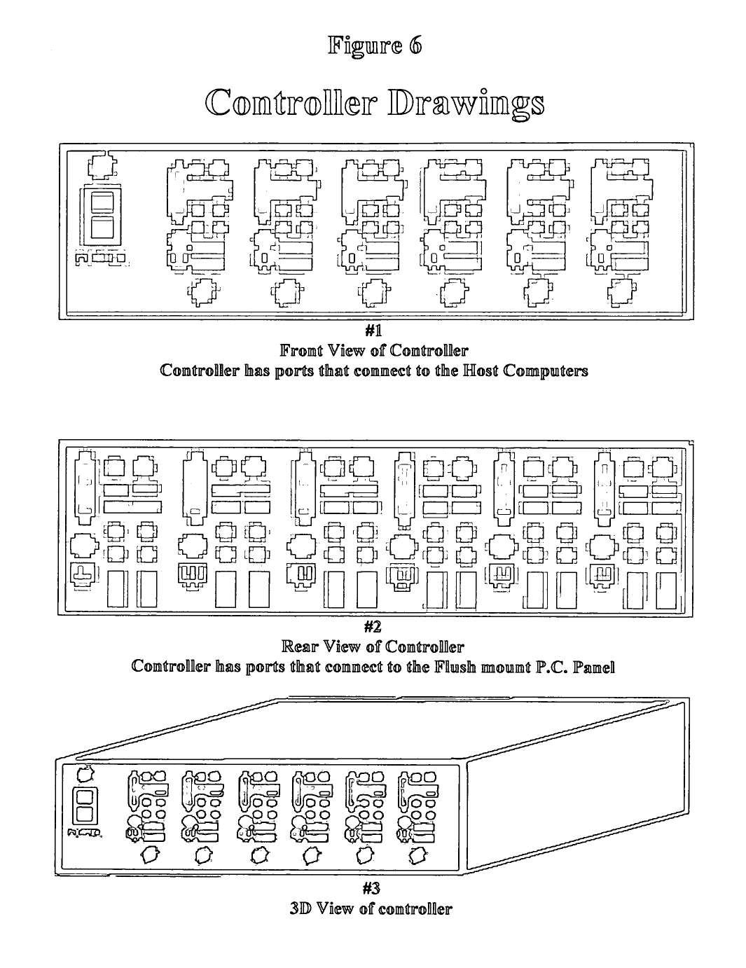

FIG. 7 depicts the Computer Everywhere Wall System pre-made cable. This cable will come in several standard links and can be custom made per customers request. This way the technician in the field can easily and quickly install the system. #1 of FIG. 7 depicts the end of the cable that would plug into the controller in the computer host closet. #2 of FIG. 7 depicts the various length cable that can be ordered in standard or custom links. FIG. #3 of FIG. 7 depicts the PC Port faceplate. This could be pre-attached to the cable for easier and faster installation.

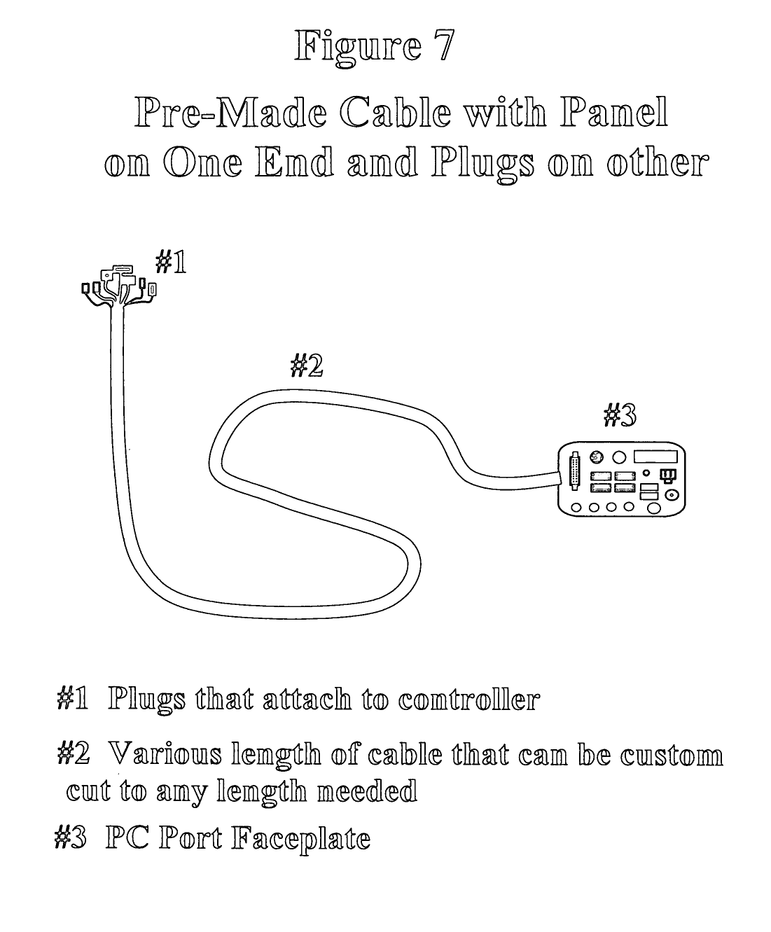

This invention has several advantages over prior art. This system allows computers to be placed in a remote location and operated in any room of a home or office. It allows the user to be distant from the noise, heat and wire clutter of the base computer unit. A user can quickly and easily plug various components into the PC Port and select which computer he/she wishes to operate and the completely control the selected computer.

The invention has been shown in one embodiment. It should be apparent to those skilled in the art that the invention is not limited to the embodiment, but is capable of being varied and modified without departing from the scope of the invention as set out in the attached claims.

1. A system that allows any wall or furnishing to become a computer, comprising the steps of; A) Isolating the main computers in a remote location, i.e. closet or room, and B) wiring or linking the computers in (A) to a controller located in the same closet or room and then; C) Cable from the controller to the Computer Everywhere Wall System Panel and DVD Player; (D) thus allowing the user to plug in a monitor and Keyboard and operate the host computers from any wired wall or room.

2. A system as recited in claim 1, the user can select and control one or more computers that are located in an isolated location (room, closet, basement, attic, etc.) of a home or office.

3. A system as recited in claim 1, wherein the host or main computer or computers in a household or office can be isolated and linked together, thus separating the user from the noise heat and exposed wire associated with personal computers.

4. A system as recited in claim 1, that would allow advertising on the faceplate of the P.C. Wall Panel, thus bringing a new way to reach customers in their own home or office.

5. A system as recited in claim 1, wherein multiple rooms and walls of a home or office could be utilized simultaneously to control a computer or computers in an isolated location(room, closet, basement, attic) within or connected to the home or office.
